(19) United States
(12) Patent Application Publication
(10) Pub. No.: US 2011/0175816 A1
(43) Pub. Date: Jul. 21, 2011

(54) MULTI-TOUCH CHARACTER INPUT METHOD

(75) Inventor: Keun-Ho Shin, Gyeonggi-Do (KR)

(73) Assignee: LAONEX CO., LTD., Gyeonggi-Do (KR)

(21) Appl. No.: 12/989,465

(22) PCT Filed: May 26, 2010
(86) PCT No.: PCT/KR10/03284

§ 371 Date: Dec. 15, 2010

(30) Foreign Application Priority Data
Jul. 6, 2009 (KR) 10-2009-0061297

(51) Int. Cl. G06F 3/02

(52) U.S. Cl. 345/168

(57) ABSTRACT

A multi-touch character input method includes the steps of: (a) preparing a character table in which characters are discriminated and arranged according to multi-touch attributes; (b) detecting a touch occurring on a touch input surface; (c) recognizing a first attribute based on the number of touch points by the touch; (d) recognizing a first character corresponding to the first attribute in the character table; and (e) detecting a change in the first attribute, and recognizing a second character induced from the first character in the character table in correspondence to a second attribute based on the change of the first attribute.

### CROSS-REFERENCE(S) TO RELATED APPLICATIONS

The present application claims priority of Korean Patent Application No. 10-2009-0061297 filed on Jul. 6, 2009, which is incorporated herein by reference in its entirety.

### FIELD OF THE INVENTION

The present invention relate to a multi-touch character input method, and more particularly, to a multi-touch character input method in which a user selects a preset character by touching one or more points through a touch screen or touch pad capable of detecting a multi-touch, and continuously induces another preset character from the previously recognized character by changing the touch state of the touch points or moving the touch points, thereby sequentially selecting a variety of characters.

### BACKGROUND ART

As the functions of mobile devices such as mobile phones, MP3 players, PMP, and PDA gradually become complex, the mobile devices may include a variety of functions at the same time. Accordingly, the division among the mobile devices tends to be vague. Therefore, even small mobile devices basically have a function of inputting a memo, a schedule management plan, or a message through a character input.

Conventional mobile devices include a mechanical button input unit for a character input. However, since the conventional mobile devices have a spatial limit, two or three characters are assigned to one button, and the size of the button is inevitably reduced. Therefore, users may feel uncomfortable when using the mobile devices.

Recently, mobile devices including a touch screen, such as smart phones, have been launched on the market. Furthermore, it is expected that the mobile devices including a touch screen are becoming more common.

The touch screen of such mobile devices may serve as an input unit as well as a display unit. Therefore, in most cases, the mobile devices include only the touch screen without separate mechanical buttons. Accordingly, when a variety of menu buttons are displayed on the touch screen to control the mobile device through the touch screen, a user may touch a menu button to execute the corresponding command.

Furthermore, a multi-touch screen has been recently adopted to provide a function through which a user may conveniently control the mobile device by using two fingers.

In order to input characters through the touch screen, a virtual keyboard is displayed on the touch screen, and a user touches the keyboard to input characters. However, the touch feeling of the touch screen is worse than that of mechanical buttons, and the division between characters is difficult to feel. Therefore, when inputting various characters by touching virtual buttons of the touch screen, the user may feel uncomfortable.

Furthermore, every language includes various characters. For example, English has 24 alphabets, and Korean has 21 characters. When all the characters are displayed on the screen, the size of each character button is inevitably reduced because of the limited space of the screen. Then, while inputting a character by touching the character button, the user may touch another character button adjacent to the character button. In this case, an error may occur in the character input process.

### DISCLOSURE OF INVENTION

### Technical Problem

The present invention is directed to a multi-touch character input method by which a user may input a variety of characters only by touching a touch screen or touch pad capable of detecting a multi-touch, without using a separate character input button or virtual key input menu.

### Technical Solution

According to an embodiment of the present invention, a multi-touch character input method includes the steps of: (A) preparing a character table in which characters are discriminated and arranged according to multi-touch attributes; (B) detecting a touch occurring on a touch input surface; (C) recognizing a first attribute based on the number of touch points by the touch; (D) recognizing a first character corresponding to the first attribute in the character table; and (E) detecting a change in the first attribute, and recognizing a second character induced from the first character in the character table in correspondence to a second attribute based on the change of the first attribute.

The step (A) may include preparing a character table in which characters are discriminated and arranged according to the number of touch points, a change in the number of touch points, and a movement direction of the touch points, the step (C) may include recognizing the number of touch points, the step (D) may include recognizing the first character corresponding to the number of touch points in the character table, and the step (E) may include the steps of: (E-1) detecting a change in the number of touch points; (E-2) when the change in the number of touch points occurs, recognizing the second character induced from the first character in the character table in correspondence to the change in the number of touch points; (E-3) detecting a movement of the touch points; (E-4) when the movement of the touch points is occurs, recognizing the movement direction of the touch points; and (E-5) recognizing a third character induced from any one of the first and second characters in the character table in correspondence to the movement direction.

The step (A) may include preparing a character table containing characters which are discriminated and arranged according to the arrangement shape of the touch points, the step (C) may include recognizing the arrangement shape of the touch points when the number of the touch points is plural, and the step (D) may include recognizing a character corresponding to the number of touch points and the arrangement shape from the character table.

The step (A) may include preparing a character table containing characters which are discriminated and arranged depending on which one of the touch points is separated or maintained, when the number of touch points is changed, and the step (E-2) may include recognizing which one of the touch points is separated or maintained when the number of touch points is changed, and recognizing a corresponding character from the character table.

The step (A) may include preparing a character table containing characters which are arranged in correspondence to a touch hold input, the step (C) may include determining whether or not the touch points is maintained in a touch hold state for a predetermined time or more, and the step (D) may include recognizing a character corresponding to the touch hold input from the character input table, when the touch input is maintained in the touch hold state.

The step (A) may include preparing a character table containing characters which are discriminated and arranged in regions obtained by dividing a touch input region, the step (B) may include dividing the entire region of the touch input surface, and detecting a divided region in which a touch input occurs, and the step (D) may include discriminating the divided region in which the touch input occurs and recognizing a corresponding character from the character table.

The step (A) may include may include preparing character tables corresponding to a plurality of input modes, respectively. When the number of touch points is plural, the step (E) may include detecting the occurrence of a double touch in the touch points, setting a corresponding input mode depending on at which one of the touch points the double touch occurs, and selecting a character table corresponding to the input mode.

The step (A) may include displaying the shape of a character corresponding to each number of touch points in the character table on a screen, and the step (D) may include arranging combinations of characters to be selected depending on the number of touch points and the movement direction of the touch points, according to the movement direction, and displaying the arranged combinations on a screen.

When the number of touch points is changed, the step (E) may include arranging combinations of characters to be selected depending on the number of touch points and the movement direction of the touch points, according to the movement direction, and displaying the arranged combinations on a screen.

### Advantageous Effects

According to the embodiment of the present invention, a user may input a variety of characters by simply touching a touch input surface capable of detecting a multi-touch. Therefore, separate character input buttons or virtual key input menus do not need to be provided.

Furthermore, as auser changes a touch input operation at each stage, the range of selectable characters may be gradually narrowed. Furthermore, as the selectable characters at each stage are displayed as a screen shot, the user may input a character more conveniently.

### BRIEF DESCRIPTION OF THE DRAWINGS

FIG. 1 is a flow chart showing a multi-touch character input method according to an embodiment of the present invention.

FIG. 2 is a flow chart explaining the operation process of FIG. 1 in more detail.

FIG. 3 a diagram showing a first screen shot and a second screen shot for helping a user to input a character in the multi-touch character input method according to the embodiment of the present invention.

FIG. 4 is a diagram showing an example in which character inputs are discriminated depending on the arrangement shapes of touch points.

FIG. 5 is a screen shot showing that characters to be inputted are differently set depending on the number of touch points in FIG. 4.

FIG. 6 is a diagram showing screen shots on the screen in the embodiment of FIGS. 4 and 5.

FIG. 7 is a diagram showing an example in which 10 numbers of 0 to 9 are inputted according to a method derived from the Roman numerals.

FIG. 8 is a diagram showing an example in which special characters such as [,],{,},<, and > are inputted.

FIG. 9 is a diagram showing an example in which inputs for function keys such as Space, Backspace, Delete, and Return are performed.

FIG. 10 is a diagram showing an example in which editing functions such as Copy, Cut, and Paste are inputted.

FIG. 11 is a diagram showing an example in which the touch input region is divided into two parts to discriminate the types of characters to be inputted.

FIG. 12 is a diagram showing an example in which an input mode is changed through a double touch.

FIG. 13 is a diagram showing an example in which a character group is selected depending on the number of touch points and the position of the touch points.

FIG. 14 is a diagram showing an example in which a character group is selected depending on an auxiliary key input and a touch position.

FIG. 15 is a diagram showing an example in which a character group is selected depending on a shape formed by a plurality of touch inputs.

FIG. 16 is a diagram showing an example in which a character group is selected according to sequential touch inputs.

FIG. 17 is a diagram showing an example in which a plurality of character groups are selected by a multi-touch input.

FIG. 18 is a diagram showing an example in which one character group is selected in a state in which a plurality of character groups are selected as shown in FIG. 17.

FIG. 19 is a diagram showing an example in which when a touch input occurs within a predetermined time after the selection for the plurality of character groups is released, one character group is selected.

### EMBODIMENT FOR CARRYING OUT THE INVENTION

Exemplary embodiments of the present invention will be described below in more detail with reference to the accompanying drawings.

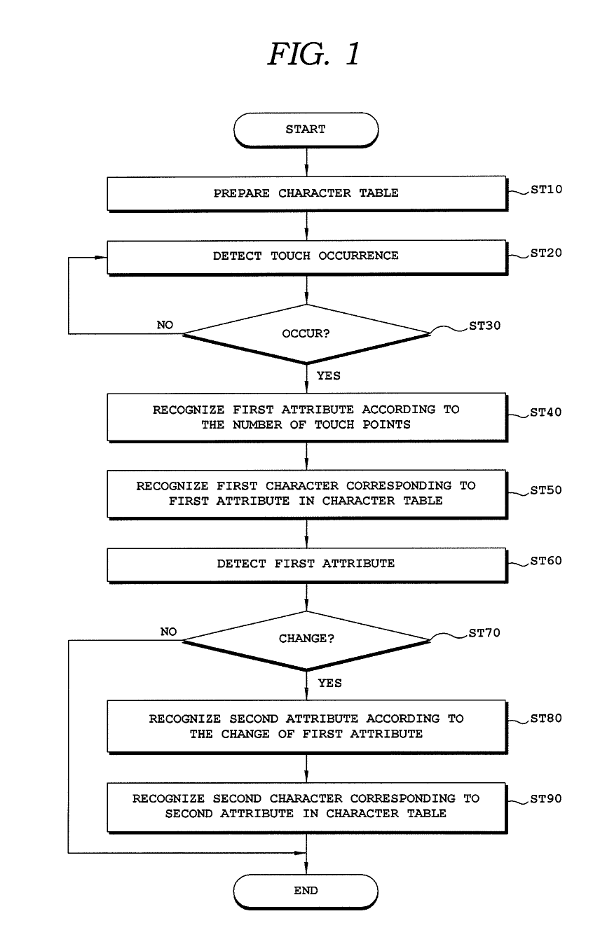

FIG. 1 is a flow chart showing a multi-touch character input method according to an embodiment of the present invention.

The multi-touch character input method according to the embodiment of the present invention may be applied to mobile devices including a touch screen or touch pad having a touch input surface, such as mobile phones, MP3 players, PMP, and PDA. Furthermore, the multi-touch character input method may be applied to general electronic apparatuses having a touch input function. Hereinafter, the electronic apparatuses having a touch input function are referred to as touch devices.

First, a character table in which characters are discriminated and arranged for attributes of the multi-touch is prepared in the touch device (step S10). At this time, the characters may include general characters, special characters, numbers, function keys, and editing keys. Furthermore, characters which will be described in claims may be analyzed as the same meaning.

In this embodiment, a multi-touch indicates a case in which a user touches one or more points on the touch input surface, and the touch device has a function of detecting the multi-touch. Whether or not to consider a multi-touch to be a normal multi-touch may be determined depending on the distance between the touched points, and the range may be set for users' convenience.

The attributes of the multi-touch may include the number of touch points, a shape formed by touch points on the touch input surface, a change in the number of touch points when a user takes a finger off or puts a finger on the touch input surface, and the movement direction of touch points when a user moves the touch points while maintaining the touch state. Furthermore, various other attributes derived from the multi-touch may be utilized as input discrimination operations.

The character table includes characters which are discriminated and arranged for the respective attributes of the multi-touch. The characters may be simply arranged in correspondence to the attributes. However, when combinations of the multi-touch attributes are used, the characters may arranged in more various manners. That is, since a user may change the multi-touch attributes through the touch device, the character table may be configured in such a manner that the types of characters are reduced in each change step.

The touch device detects a touch occurring on the touch input surface in real time (step S20).

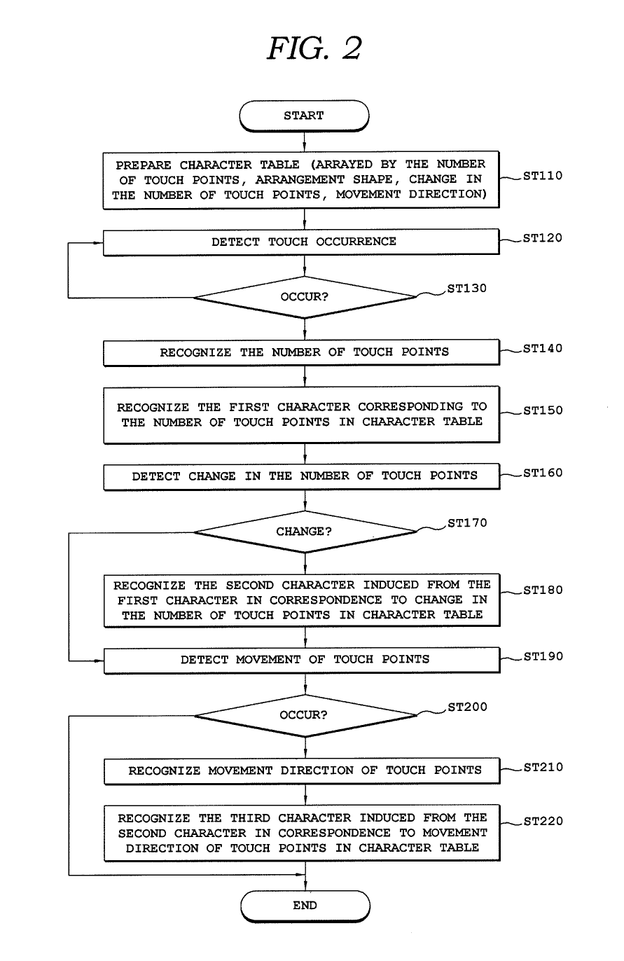

When a touch occurs on the touch input surface (step S30), the touch device recognizes a first attribute according to the number of touch points (step S40). The first attribute which is an attribute close to the number of touch points may directly indicate the number of touch points or may indicate an extended concept. This will be described below in detail with reference to FIG. 2.

After the first attribute is recognized, the touch device recognizes a first character corresponding to the first attribute in the preset character table (step S50).

An input character may be selected only by the above-described steps. However, the range of character selection may be extended by a subsequent operation of the user.

For this, the touch device detects a change of the first attribute (step S60).

When the change of the first attribute is detected (step S70), the touch device recognizes a second attribute depending on the change of the first attribute (step S80). Here, the second attribute is related to the change of the first attribute, and may indicate a change in the number of touch points or a movement of the touch points. This will be described below in detail with reference to FIG. 2.

The touch device recognizes a second character induced from the first character in the character table in correspondence to the second attribute depending on the change of the first attribute (step S90). That is, the second character may be selected from a group of characters which may be subsequently selected in a state in which the first character is recognized.

As the touch operation of the user is continuously changed, a third character induced from the second character may be selected. This will be described below in detail with reference to FIG. 2.

FIG. 2 is a flow chart explaining the operation process of FIG. 1 in more detail. FIG. 2 shows a specific embodiment of the character input method of FIG. 1. In FIG. 2, input characters may be selected by detecting touch operations of a user in order of (1) the number of touch points, (2) a change in the number of touch points, and (3) a movement direction of the touch points.

First, a character table is prepared in the touch device (step S110). The character table may be previously provided in a hardware manner, or may be provided by installing a program after a product is launched. The character table includes characters which are discriminated and arranged depending on the number of touch points, a change in the number of touch points, and a movement direction of the touch points.

Next, the touch device detects a touch occurring on the touch input surface in real time (step S120). At this time, the touch device may detect one or more touch points as well as whether a touch occurs or not. That is, the touch device may detect a multi-touch.

When a touch occurs (step S130), the touch device recognizes the number of touch points by the touch (step S140). Furthermore, the touch device recognizes a first character corresponding to the number of touch points in the character table (step S150). For example, when the number of touch points is one, the touch device recognizes the touch as a character ‘O’ set in the character table. When the number of touch points is two, the touch device recognizes the touch as a character ‘U’ set in the character table. When the number of touch points is three, the touch device recognizes the touch as a character ‘A’ set in the character table.

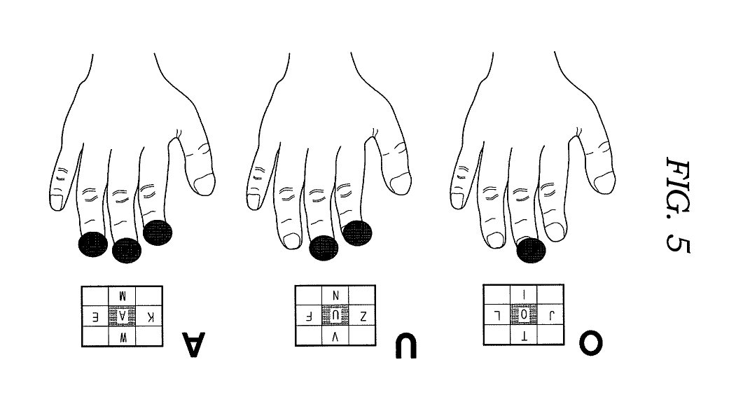

Furthermore, when characters are divided and set in the character table according to the arrangements of touch points, the touch device recognizes the arrangement shape of two or more touch points and then recognizes a character corresponding to the arrangement shape. FIG. 5 shows a case in which, when the number of touch points is two or more, a character is recognized according to the arrangement shape of the touch points.

Then, the touch device detects a change in the number of touch points (step S160). The change in the number of touch points indicates a case in which, although a user first forms touch points by using two fingers, the user takes off any one finger such that the number of touch points is changed to one.

Furthermore, even in the change in the number of touch points, different characters may be recognized depending on which one of the touch points is maintained or separated. For this, the character table may include characters which are previously set depending on the change in the number of touch points and which one of the touch points is maintained or separated. Furthermore, the touch device needs to have a function capable of recognizing which one of the touch points is maintained or separated.

Therefore, when a change in the number of touch points occurs (step S170), the touch device recognizes the second character induced from the first character in the character table in correspondence to the change in the number of touch points (step S180). Furthermore, as described above, characters may be discriminated and assigned depending on which one of the touch points is maintained or separated.

For example, when the user touches two points, the touch device may recognize a character ‘U’ at the step S150.

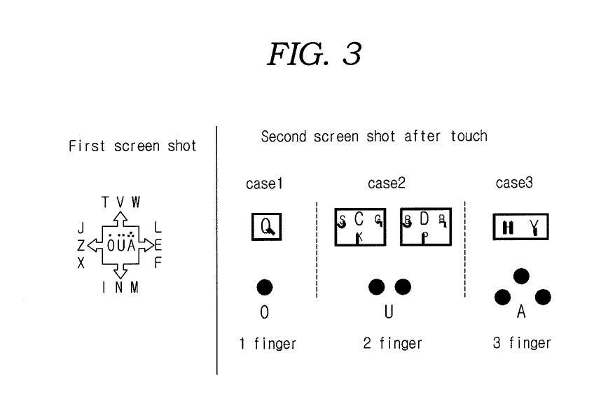

In this state, when the user takes a finger off the right touch point such that only the left touch point is maintained, a character ‘C’ is recognized as the second character induced from the first character. That is, the currently-selected character is changed from ‘U’ to ‘C’. This will be described below in detail with reference to FIG. 3.

Then, the touch device detects a movement of the touch point (step S190). When the movement of the touch point occurs (step S200), the touch device recognizes the movement direction of the touch point (step S210). For example, the touch device detects that the touch point is moved in an upward/downward or left/right direction or a diagonal direction. That is, the user may select a character by moving the touch point as well as by changing the number of touch points.

The touch device recognizes a third character induced from any one of the first and second characters in the character table in correspondence to the movement direction of the touch point (step S220).

That is, the user may select the first character by touching the touch input surface, may select the second character by changing the number of touch points, or may select the third character by moving the touch points in a state in which the number of touch points is changed. Furthermore, the user may select another third character by moving the touch points in a state in which the number of touch points is not changed.

FIG. 3 a diagram showing a first screen shot and a second screen shot for helping a user to input a character in the multi-touch character input method according to the embodiment of the present invention.

The first and second screen shots properly show a user characters which may be selected among the characters set in the character table of the touch device, for each stage.

The first screen shot is an image which is displayed before the user makes a touch input. When the number of touch points is one, a character ‘O’ is recognized. When the number of touch points is two, a character ‘U’ is recognized. When the number of touch points is three, a character ‘A’ is recognized. Furthermore, the first screen shot shows which characters are recognized when the touch is moved in each case.

For example, after the user may touch the touch input surface with one finger such that a character ‘O’ is recognized, the user moves the touch point in the upward/downward or left/right direction such that a character ‘T’, ‘I’, ‘J’, or ‘L’ is recognized. For characters ‘U’ and ‘A’, the same process may be applied.

The second screen shot is an image which is displayed in a state in which one character is recognized by touching the touch input surface, and shows how a character is selected depending on a change in the number of touch points and a movement direction of the touch points.

For example, the user may touch the touch input surface with two fingers such that a character ‘U’ is recognized. In this state, when the user takes the right finger off such that only the left touch point is maintained, the character ‘U’ is changed to a character ‘C’. In this state, when the user moves the touch point to the left side, a character ‘S’ is recognized, and the character ‘C’ is changed to the character ‘S’.

Similarly, the user may touch the touch input surface with three fingers such that a character ‘A’ is recognized. In this state, when the user takes the left and right fingers off such that only the center touch point is maintained, a character ‘Y’ is recognized.

Furthermore, the user may touch the touch input surface with one finger such that a character ‘O’ is selected. In this case, when the user moves the touch point in the diagonal direction, a character ‘Q’ may be recognized. In this way, all the 26 alphabets of English may be recognized.

The English alphabets are arranged in consideration of the similarities to the touch operations, and the arrangement principle may be explained by the shapes of the alphabets and solid lines which are additionally indicated in the second screen shot of FIG. 3. That is, the alphabets ‘O’, ‘U’, and ‘A’ have a similarity to the shapes of the touch points, respectively, and the alphabets ‘C’ and ‘D’ have a convex shape in a direction in which the touch is maintained, depending on the change in the number of touch points. The alphabets ‘H’ and ‘Y’ are arranged by emphasizing the touch which is maintained after the number of points is changed.

The alphabets ‘S’, ‘G’, ‘K’, ‘B’, ‘R’, and ‘P’, which are selected according to the movement direction of the touch points after the alphabets ‘C’ and ‘D’ are selected, are arranged by considering the similarity between the movement direction of the touch points and the shape of lines composing a character.

The above-described arrangement of the 26 alphabets of English is only an example, and may be implemented in more various manners. Furthermore, characters of another language may also be arranged in various manners.

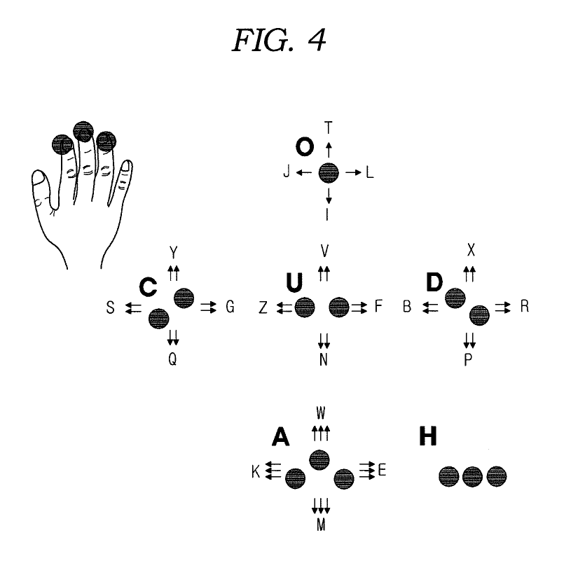

FIG. 4 is a diagram showing an example in which character inputs are discriminated depending on the arrangement shapes of touch points. When the number of touch points is one, the character input is performed in the same manner as described above. In FIG. 3, when the number of touch points is two or more, a subsequent character is selected by a change in the number of touch points as described above. In FIG. 4, however, a subsequent character is selected according to the arrangement shape of the touch points.

That is, when a user touches the touch input surface with two fingers, a character is selected depending on an inclination formed by the two points. For example, when the two points are at a level with each other, ‘U’ is recognized. When the two points form an inclination, ‘C’ or ‘D’ is recognized depending on the direction of the inclination. After that, different characters may be recognized depending on the upward/downward and left/right movement directions of the touch.

The example of FIG. 4 is different from that of FIG. 3 in that the characters are arranged in such a manner that ‘Y’ or ‘Q’ are selected depending on the upward or downward movement of the touch points on the basis of ‘C’. Therefore, the touch points do not need to be moved in the diagonal direction to recognize ‘Q’, and the input of ‘Y’ in the three-finger touch is substituted. Furthermore, when the touch points are moved upward after ‘D’ is selected, ‘X’ is selected.

Furthermore, when a user touches the touch input surface with three fingers, characters are selected depending on the shape formed by the touch points. That is, when the shape formed by the touch points is close to a triangle, ‘A’ is recognized. At this time, the example of FIG. 3 is different from the example of FIG. 3 in that when the touch points are moved in the left direction after ‘A’ is recognized, ‘K’ is recognized. Furthermore, when the three points are at a level with one another, ‘H’ is recognized.

In order to recognize characters depending on the arrangement shapes of the touch points, the touch device needs to have a function capable of recognizing a multi-touch and the arrangement shape of multiple touch points. Reference values for discriminating the respective arrangement shapes may be set according to the convenience of users.

FIG. 5 is a screen shot showing that characters to be inputted are differently set depending on the number of touch points in FIG. 4. That is, when a user touches the touch input surface with only one finger, ‘O’ is selected. After that, ‘J’, ‘T’, ‘L’, or ‘I’ may be selected depending on the movement direction of the touch point.

Furthermore, when the user touches the touch input surface with two fingers such that the touch points are at a level with each other, ‘U’ is selected. After that, ‘Z’, ‘V’, ‘F’, or ‘N’ may be selected depending on the movement direction of the touch points. Furthermore, when the user touches the touch input surface such that the touch points form an inclination, ‘C’ or ‘D’ may be inputted as described with reference to FIG. 4. Then, subsequent characters may be selected depending on the movement directions of the touch points.

When the user touches the touch input surface with three fingers such that the touch points forms a triangle, ‘A’ is selected. After that, ‘K’, ‘W’, ‘E’, or ‘M’ may be selected depending on the movement direction of the touch points. Furthermore, when the user touches the touch input surface with three fingers such that the touch points are at a level with one another, ‘H’ may be selected as described with reference to FIG. 4.

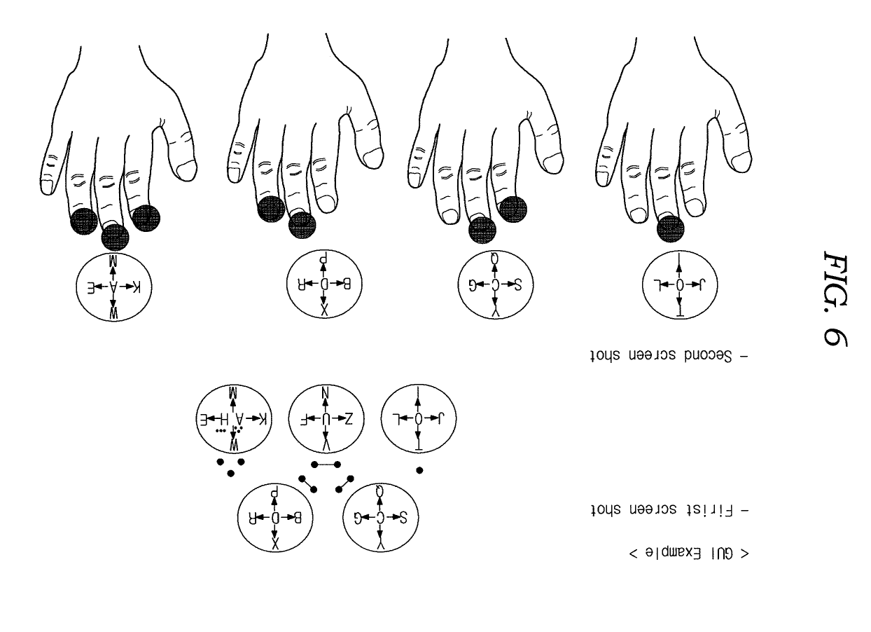

FIG. 6 is a diagram showing screen shots on the screen in the embodiment of FIGS. 4 and 5. The first screen shot of FIG. 6 is different from that of FIG. 3 or 5 in that all the 26 alphabets of English are displayed so that a user may conveniently select a character. The arrangement shapes of the alphabets may be implemented in the same manner as the embodiment of FIGS. 4 and 5.

In the second screen shot of FIG. 6, the user may select a subsequent character after touching the touch input surface. In a state in which the second screen shot is displayed, the user may select a character by moving the touch points.

The examples in which English alphabets are inputted have been described with reference to FIGS. 3 to 6.

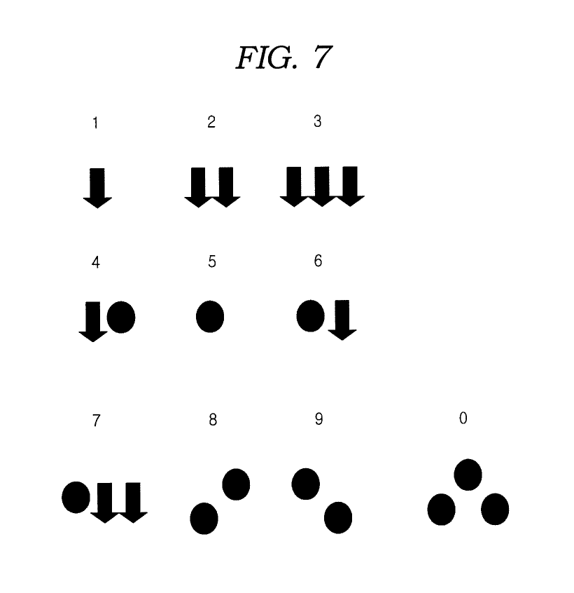

Referring to FIGS. 7 to 10, examples in which numbers, special characters, function keys, and editing functions are inputted will be described.

FIG. 7 is a diagram showing an example in which 10 numbers of 0 to 9 are inputted according to a method derived from the Roman numerals.

The numbers of 1, 2, and 3 are recognized by touching one, two, and three points, respectively, and moving the touch points downward.

The numbers of 4 and 6 are recognized by touching two points and moving one of the two points downward.

The number of 5 is recognized by touching one point, and the number of 7 is recognized by touching three points and moving two points in the left side downward.

The numbers of 8 and 9 are inputted by touching two points, and may be discriminated depending on the direction of the inclination formed by the two touch points.

The number of 0 is recognized by touching three points in the form of a triangle.

Since such a number input method is similar to a method of writing the Roman numerals, it has an advantage in that the number input method is easily remembered.

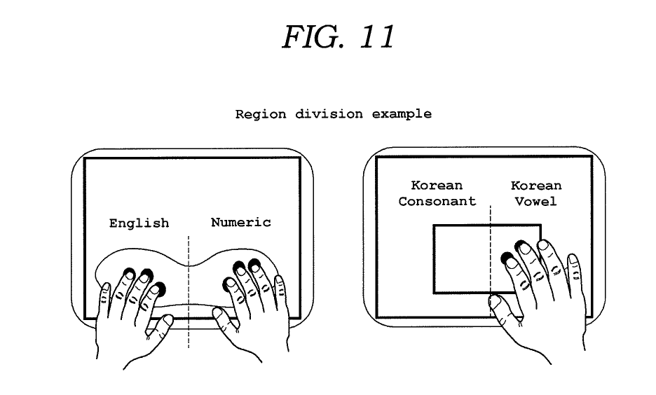

At this time, the number input method may be partially overlapped with the character input method. In order to solve such a problem, the touch screen may be divided into two parts such that characters and numbers may be discriminated and recognized. This will be described with reference to FIG. 11.

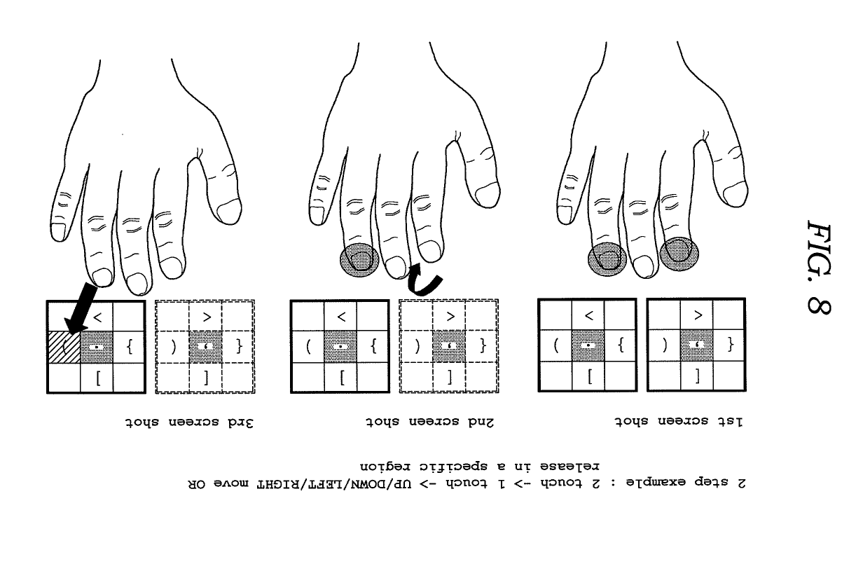

FIG. 8 is a diagram showing an example in which special characters such as [,],{,},<, and > are inputted. This embodiment may be extended from the embodiments of FIGS. 4 to 6. As described above, FIGS. 4 to 6 show the examples in which all the 26 alphabets of English are inputted by the number of touch points, the arrangement shapes of the touch points, and the movement direction of the touch points. FIGS. 8 to 10 show examples in which the input method is extended by changing the number of touch points.

The process for changing the number of touch points has been already described with reference to FIG. 3. In this method, the number of touch points may be changed by taking a finger off the touch input surface or additionally touching the touch input surface with an unused finger, in order to extend the touch input. Furthermore, after the number of touch points is changed, a part of the touch points may be moved to further extend the touch input. In this case, a corresponding character may be determined only by an operation of moving the touch points in the upward/downward or left/right direction. Furthermore, the touch points may be moved to the position of a character image of the screen shot displayed on the screen, and the fingers may be released to determine the corresponding character.

FIG. 8 shows an example in which parenthesis-type special characters are inputted. In this embodiment, a user touches two points of the touch screen and then separates one of the two points to input a left or right parenthesis character.

That is, after the user touches two points of the touch screen with two fingers such that the two points are spaced a predetermined distance from each other, the user may separate the left finger, move the right finger in the upward/downward or left/right direction or to a character image on the screen, and release the right finger to input a special character such as ], >, }, or ). On the other hand, the user may separate the right finger, move the left finger in the upward/downward or left/right direction or to a character image on the screen, and release the left finger to input a special character such as [,<,{, or (.

At this time, the operation may be duplicated with the operation of inputting ‘U’ in FIG. 4, in that two points are touched. Referring to FIG. 8, however, a reference value may be properly set in such a manner that when two points are touched at a distance between the second and fourth fingers, the touch is recognized as a special character input.

Furthermore, although the special character input is not discriminated from the operation of inputting ‘U’, the special character input may be selected only by separating one of two touch points. Therefore, the special character input may be implemented without setting a reference value for the distance between two touch points.

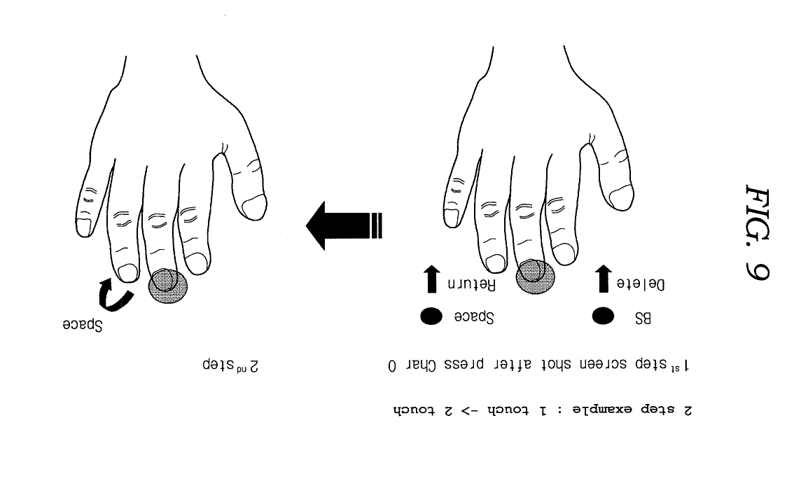

FIG. 9 is a diagram showing an example in which inputs for function keys such as Space, Backspace, Delete, and Return are performed. Similar to FIG. 8, this input method may be extended from the examples of FIGS. 4, 5, and 6. In FIG. 8, two points are touched and one of the two touch points is separated to perform an input. In FIG. 9, however, one point is touched, and a touch point is added to perform an input.

First, a user may touch the touch input surface with one finger. In this case, the touch is performed in the same manner as the character ‘O’ is inputted as described with reference to FIG. 4. As a subsequent operation, the user additionally touches a left or right position of the touch point.

The function key such as Space, Backspace, Delete, or Return is recognized by the additional touch operation. For example, when the left position is additionally touched, this may be recognized as a touch for Backspace. Alternatively, when the right position is additionally touched, this may be recognized as a touch for Space. Such a function key recognition process may be carried out as soon as the additional touch is performed, or when the additional touch is separated as shown in the second step of FIG. 9.

Furthermore, as the additional touch point is moved, a function key may be recognized. For example, when the left position is touched and then moved downward, this may be recognized as an input for Delete. Alternatively, when the right position is touched and then moved downward, this may be recognized as an input for Return.

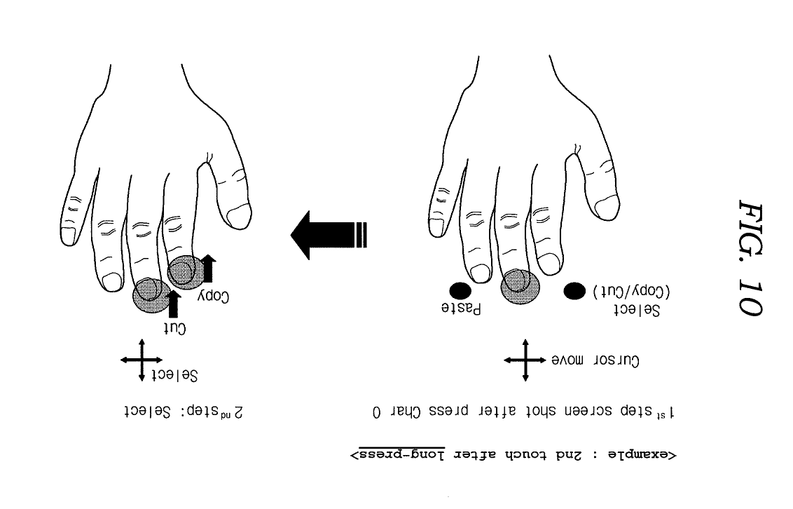

FIG. 10 is a diagram showing an example in which editing functions such as Copy, Cut, and Paste are inputted. Similar to FIGS. 8 and 9, this method may be extended from the embodiments of FIGS. 4 to 6.

First, when a user touches the touch input surface with one finger and maintains the touch state for a predetermined time or more, a state for inputting the editing functions such as Copy, Cut, and Paste is prepared.

In this state, when the user moves the touch point, the cursor may be moved to a desired position on the screen. Then, the user may touch a left position to select an object on the screen. At this time, the selected object may be a text on a document, or an image or icon. In addition, various objects may be selected.

When the object is selected, an editing function for copying, cutting, or pasting the object may be selected. For example, when the user moves the left touch point downward, the Copy function may be recognized. When the user moves the initial touch point downward, the Cut function may be recognized. Furthermore, when the user additionally touches a right position, the Paste function may be recognized.

FIG. 11 is a diagram showing an example in which the touch input region is divided into two parts to discriminate the types of characters to be inputted. As described above with reference to FIG. 7, the entire region may be divided into left and right regions to discriminate and recognize numeric and English alphabets.

For example, a touch inputted through the left region may be recognized as a touch for inputting an English alphabet, and a touch inputted through the right region may be recognized as a touch for inputting a number.

This method may be applied to Korean alphabet. That is, a region for inputting a consonant and a region for inputting a vowel may be discriminated and recognized.

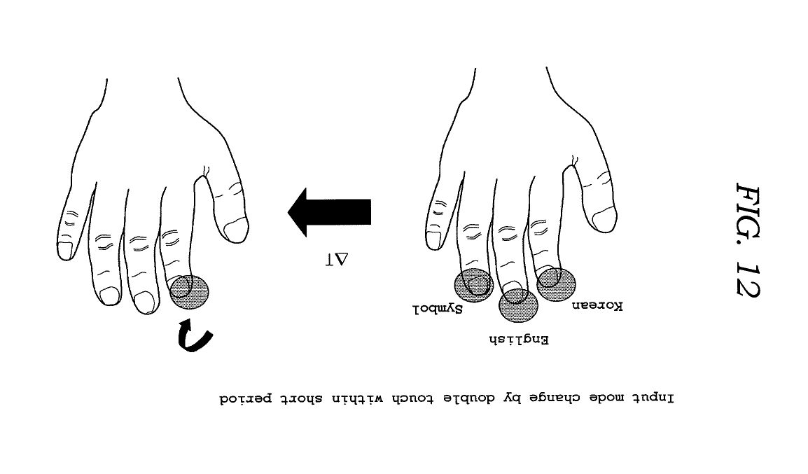

FIG. 12 is a diagram showing an example in which the input mode is changed through a double touch.

Since a variety of combinations may be created only by the above-described touch method, various numbers of cases may be generated. However, there is still a limit to generating a number of cases which may be used conveniently for input. Furthermore, a different character table for each language may be used. FIG. 11 shows the example in which the entire region of the touch input surface is divided to discriminate the type of the character. However, when the touch input surface has a small size, the user may feel uncomfortable while inputting a touch.

To solve such a problem, FIG. 12 shows an example in which the input mode is changed only by a touch input. First, the touch device includes a character table corresponding to each input mode. For example, the touch device may include a character table for English alphabets, a character table for Korean alphabets, and a character table for special characters. Therefore, a touch input may be performed in the same manner among the respective character tables. However, as the input modes for the respective character tables are discriminated, it is possible to discriminate a character to be inputted.

To set an input mode, a user touches a plurality of points of the touch input surface with fingers. Then, the user double-touches any one of the touch points to set an input mode. At this time, the double touch means that a second touch is performed within a short period without a position movement. The time difference for recognizing the double touch may be set to an arbitrary value. However, the time difference may be set to a value which may be recognized by a user, but is not too long, like a double click of a mouse device.

For example, when the user touches three points, the left touch point may correspond to the Korean input mode, the center touch point may correspond to the English input mode, and the right touch point may correspond to the special character input mode. In this case, when the user double-touches the left touch point, the input mode may be set to the Korean input mode. Then, a subsequent touch input is performed to recognize a character from the character table corresponding to the Korean input mode. The input mode may be changed through the double touch as described above.

Hereinafter, a process in which a character group composed of a plurality of characters is selected according to a touch input will be described with reference to drawings. For convenience of description, it is assumed that three character groups are arranged in the upper side and two character groups are arranged in the lower side. Furthermore, it is assumed that the touch input region of the touch screen or touch pad is divided into left and right regions.

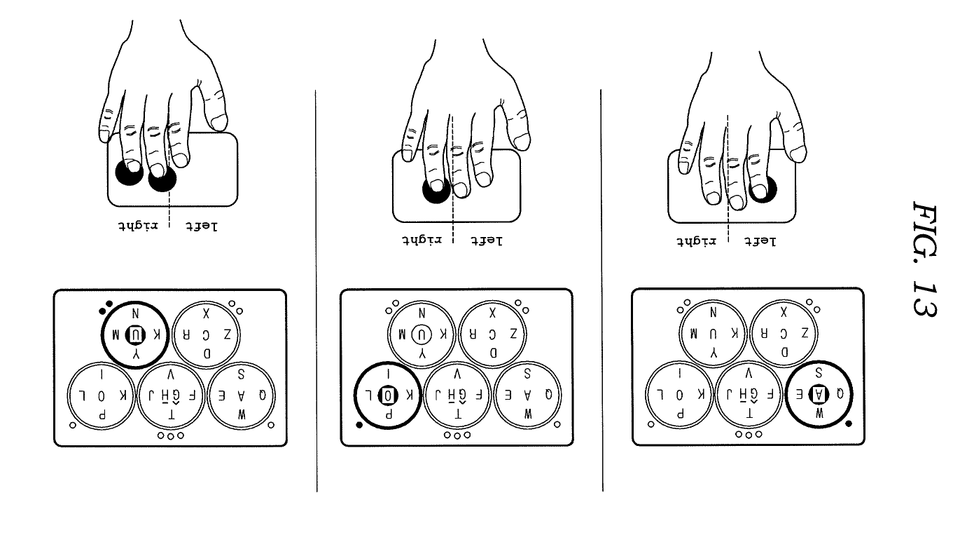

FIG. 13 is a diagram showing an example in which a character group is selected depending on the number of touch points and the position of the touch points. Referring to FIG. 13, when one touch is inputted to the left region of the touch input region, a left character group among the character groups arranged in the upper side is selected as shown in the left drawing of FIG. 13. When one touch is inputted to the right region of the touch input region, a right character group among the character groups arranged in the upper side is selected as shown in the central drawing of FIG. 13. Furthermore, when two touches are inputted to the right region of the touch input region, a right character group between the character groups arranged in the lower side is selected as shown in the right drawing of FIG. 13.

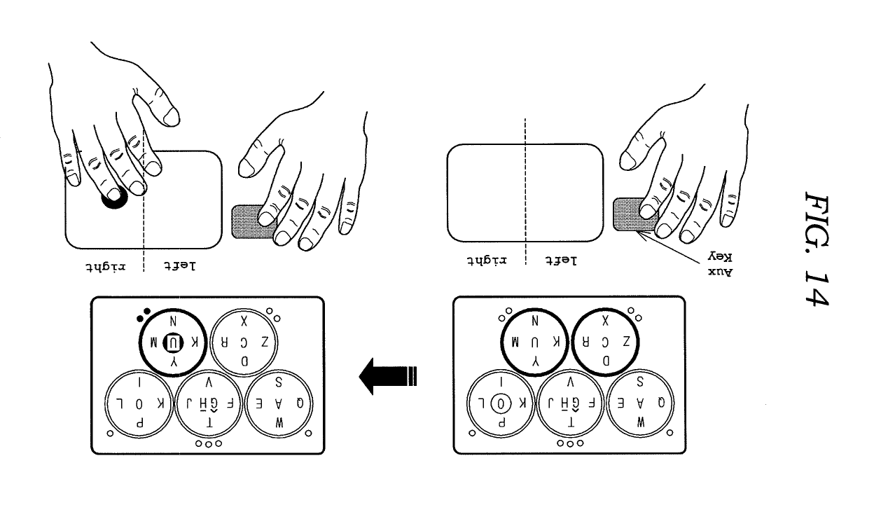

FIG. 14 is a diagram showing an example in which a character group is selected depending on an auxiliary key input and a touch position. For convenience of description, it is assumed that an auxiliary key is provided to select one of two character group lines. Referring to FIG. 14, when one touch is inputted to the right region of the touch input region in a state in which the auxiliary key is held down, a right character group between character groups arranged in the lower side is selected.

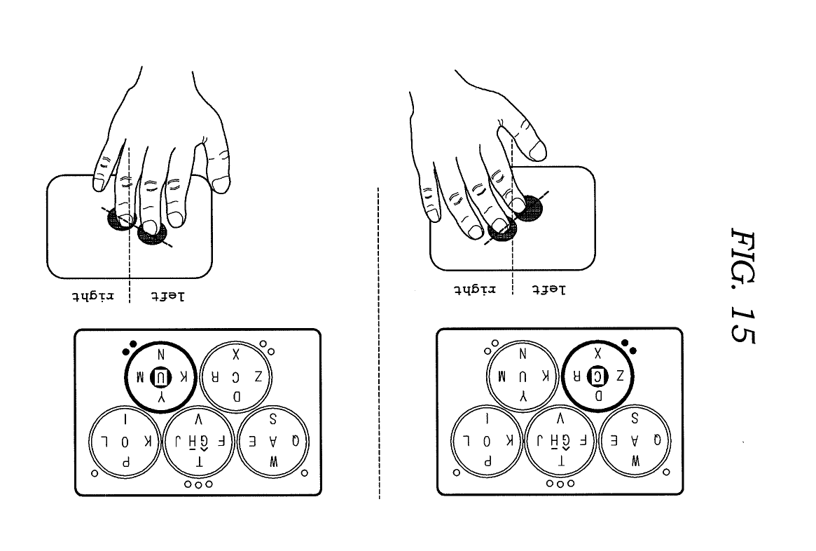

FIG. 15 is a diagram showing an example in which a character group is selected depending on a shape formed by a plurality of touch inputs. In FIG. 15, it is assumed that two touch inputs are performed. When the left touch input of the two touch inputs is positioned at a position which is lower by a predetermined level than the right touch input, a left character group between the character groups arranged in the lower side is selected as shown in the left drawing of FIG. 15. When the right touch input of the two touch inputs is positioned at a position which is lower by a predetermined level than the left touch input, a right character group between the character groups arranged in the lower side is selected as shown in the right drawing of FIG. 15. The setting may be performed in the other way.

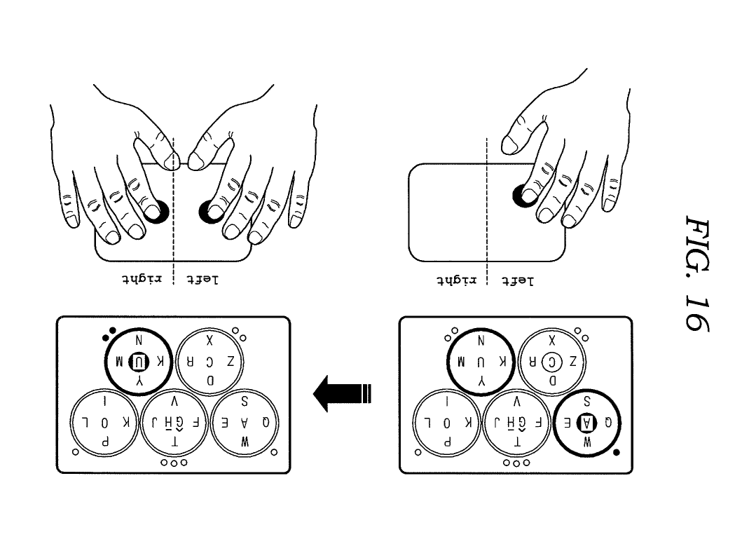

FIG. 16 is a diagram showing an example in which a character group is selected according to sequential touch inputs. Referring to FIG. 16, when one touch is inputted to the left region of the touch input region, the left character group among the character groups arranged in the upper line and the right character group between the character groups arranged in the lower line are selected. Then, when an additional touch is inputted to the right region of the touch input region, the right character group between the character groups arranged in the lower line is selected.

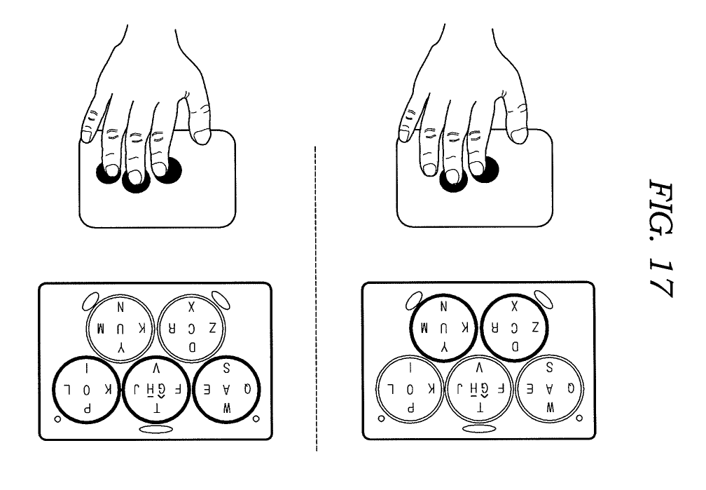

FIG. 17 is a diagram showing an example in which a plurality of character groups is selected by a multi-touch input. Referring to FIG. 17, when two touch inputs occur at the same time, all the character groups arranged in the lower line are selected. When three touch inputs occur at the same time, all the character groups arranged in the upper line are selected.

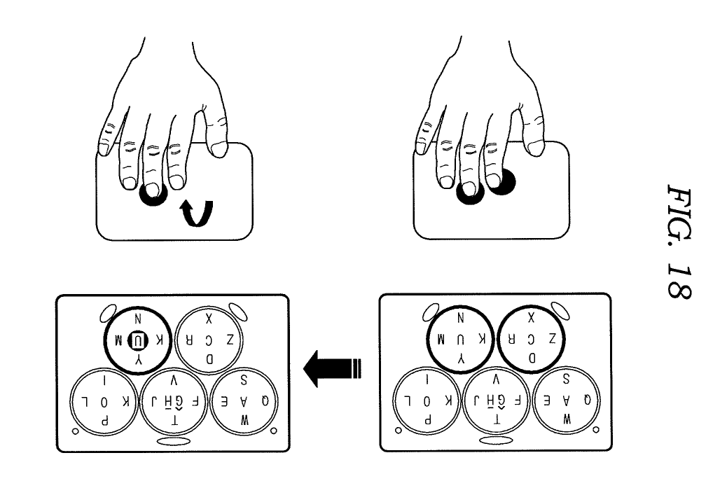

FIG. 18 is a diagram showing an example in which one character group is selected in a state in which a plurality of character groups are selected as shown in FIG. 17. Referring to FIG. 18, when only the left touch is released in a state in which all the character groups arranged in the lower line are selected, the right character group between the character groups positioned in the lower line is selected.

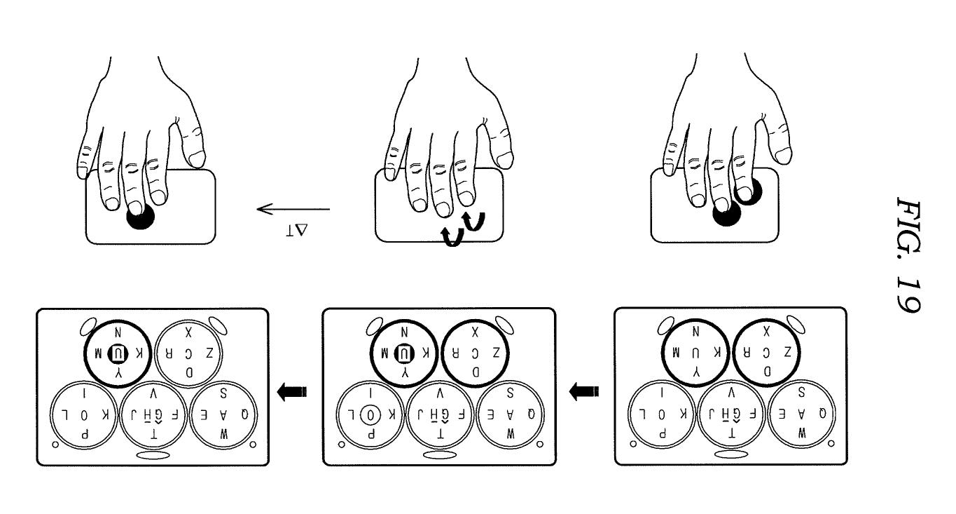

FIG. 19 is a diagram showing an example in which when a touch input occurs within a predetermined time after the selection for the plurality of character groups is released, one character group is selected.

Referring to FIG. 19, when one touch is inputted to the right region of the touch input region within a predetermined time after the two touch inputs are released in a state in which all the character groups arranged in the lower line are selected, the right character group between the character groups arranged in the lower line is selected.

While the present invention has been described with respect to the specific embodiments, it will be apparent to those skilled in the art that various changes and modifications may be made without departing from the spirit and scope of the invention as defined in the following claims.

1. A multi-touch character input method comprising the steps of:
(A) preparing a character table in which characters are discriminated and arranged according to multi-touch attributes;
(B) detecting a touch occurring on a touch input surface;
(C) recognizing a first attribute based on the number of touch points by the touch;
(D) recognizing a first character corresponding to the first attribute in the character table; and
(E) detecting a change in the first attribute, and recognizing a second character induced from the first character in the character table in correspondence to a second attribute based on the change of the first attribute.

2. The multi-touch character input method of claim 1, wherein the step (A) comprises preparing a character table in which characters are discriminated and arranged according to the number of touch points, a change in the number of touch points, and a movement direction of the touch points,
the step (C) comprises recognizing the number of touch points,
the step (D) comprises recognizing the first character corresponding to the number of touch points in the character table, and
the step (E) comprises the steps of:
(E-1) detecting a change in the number of touch points;
(E-2) when the change in the number of touch points occurs, recognizing the second character induced from the first character in the character table in correspondence to the change in the number of touch points;
(E-3) detecting a movement of the touch points;
(E-4) when the movement of the touch points is occurs, recognizing the movement direction of the touch points; and
(E-5) recognizing a third character induced from any one of the first and second characters in the character table in correspondence to the movement direction.

3. The multi-touch character input method of claim 2, wherein the step (A) comprises preparing a character table containing characters which are discriminated and arranged according to the arrangement shape of the touch points,
the step (C) comprises recognizing the arrangement shape of the touch points when the number of the touch points is plural, and
the step (D) comprises recognizing a character corresponding to the number of touch points and the arrangement shape from the character table.

4. The multi-touch character input method of claim 3, wherein the step (A) comprises preparing a character table containing characters which are discriminated and arranged depending on which one of the touch points is separated or maintained, when the number of touch points is changed, and
the step (E-2) comprises recognizing which one of the touch points is separated or maintained when the number of touch points is changed, and recognizing a corresponding character from the character table.

5. The multi-touch character input method of claim 4, wherein the step (A) comprises preparing a character table containing characters which are arranged in correspondence to a touch hold input,
the step (C) comprises determining whether or not the touch points is maintained in a touch hold state for a predetermined time or more, and
the step (D) comprises recognizing a character corresponding to the touch hold input from the character input table, when the touch input is maintained in the touch hold state.

6. The multi-touch character input method of claim 5, wherein the step (A) comprises preparing a character table containing characters which are discriminated and arranged in regions obtained by dividing a touch input region,
the step (B) comprises dividing the entire region of the touch input surface, and detecting a divided region in which a touch input occurs, and
the step (D) comprises discriminating the divided region in which the touch input occurs and recognizing a corresponding character from the character table.

7. The multi-touch character input method of claim 5, wherein the step (A) further comprises preparing character tables corresponding to a plurality of input modes, respectively,
when the number of touch points is plural, the step (E) comprises detecting the occurrence of a double touch in the touch points, setting a corresponding input mode depending on at which one of the touch points the double touch occurs, and selecting a character table corresponding to the input mode.

8. The multi-touch character input method of claim 1, wherein the step (A) comprises displaying the shape of a character corresponding to each number of touch points in the character table on a screen, and
the step (D) comprises arranging combinations of characters to be selected depending on the number of touch points and the movement direction of the touch points, according to the movement direction, and displaying the arranged combinations on a screen.

9. The multi-touch character input method of claim 8, wherein when the number of touch points is changed, the step (E) comprises arranging combinations of characters to be selected depending on the number of touch points and the movement direction of the touch points, according to the movement direction, and displaying the arranged combinations on a screen.
